(19) United States
(12) Patent Application Publication
(10) Pub. No.: US 2026/0204921 A1
(43) Pub. Date: Jul. 16, 2026

(54) A METHOD TO REACT TO A PHASE CHANGE

(71) Applicant: VESTAS WIND SYSTEMS A/S, Aarhus N (DK)

(72) Inventors: Hamid SOLTANI, Silkeborg (DK); John Godsk NIELSEN, Hornslet (DK); Torsten LUND, Fredericia (DK)

(21) Appl. No.: 19/133,991

(22) PCT Filed: Dec. 14, 2023
(86) PCT No.: PCT/DK2023/050310

§ 371 Date: May 29, 2025

(30) Foreign Application Priority Data
Dec. 23, 2022 (DK) PA202201219

(51) Int. Cl. H02J 3/44; H02J 3/34; H02J 3/36; H02J 3/38; H02J 101/28

(52) U.S. Cl. CPC H02J 3/44; H02J 3/34; H02J 3/36; H02J 3/381; H02J 2101/28

(57) ABSTRACT

The present invention relates a method for controlling a power generating unit connected to an electrical grid, during a fault ride through event, wherein the fault ride through event causes a phase jump in the electrical grid, the method comprises the steps of: measuring a voltage signal of the power generation unit, calculating a phase angle, based on the measured voltage, in a phase look loop (PLL) block, comparing the phase angle with previous measured phase angle, and calculate a phase angle change, detecting if the phase angle change larger than a threshold and changing to an another state by a Fault Ride Through State machine (FRTSM) for which the power generation unit shall operate, after the threshold has been exceeded.

### FIELD OF THE INVENTION

The invention relates to a method for controlling a power generating unit connected to an electrical grid during a fault ride through event, wherein the fault ride through event causes a phase jump in the electrical grid.

### BACKGROUND OF THE INVENTION

In order to allow a much higher penetration of renewable energy in a power grid. The power generating unit(s), such as wind turbines has to be operated in a smarter way. In recent years and in the future it is foreseen that the larger power plant with a plurality of power generating units will be connected to an existing electrical grid via an HVDC power converter system. Most often the HVDC system will have a DC transmission line between the two converter stations, converting AC power to DC power and back again from DC to AC power.

The plurality of power generating units will therefore only see the converter station of the HVDC system, and feed into the impedance of the HVDC system, as there will in many cases not be other consumers at that side of the HVDC system.

In case of a fault in the HVDC system or further upstream in the electrical grid it is important to have good and fast communication with the power generating units, so power can be regulated and stopped, instead of continued power in-flow to the DC system.

It is an object of the present to ensure means of fast communication to the power generating units.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claims.

According to a first aspect of the invention it is provided a method for controlling a power generating unit connected to an electrical grid, during a fault ride through event, wherein the fault ride through event causes a phase jump in the electrical grid, the method comprises the steps of:
Measuring a voltage signal of the power generation unit,
calculating a phase angle, based on the measured voltage, in a phase look loop (PLL) block,
comparing the phase angle with previous measured phase angle, and calculate a phase angle change,
detecting if the phase angle change larger than a threshold and
changing to an another state by a Fault Ride Through State machine (FRTSM) for which the power generation unit shall operate, after the threshold has been exceeded.

According to the first aspect of the invention, a fast and reliable way of informing the power generating units of either increasing or decreasing produced power has been provided.

In an embodiment the method further comprises the step of:
deciding a current limitations on the active current 710 and on the reactive current 720 output current of the power generating unit.

In an embodiment the step of current limitations comprises a ramp up of the current values.

In an embodiment the Fault Ride Through State machine (FRTSM) further comprises a latch timer, which suppresses output current of the power generating unit for a set period of time.

In an embodiment the power generating unit is a wind turbine (100).

According to a second aspect of the invention a Electrical power system comprising an HVDC power station and a plurality of power generating unit, wherein the HVDC power station generates an output AC voltage signal, with an amplitude and a phase angle, in the event the HVDC power station enters into a fault situation, the fault situation triggers a phase angle change in the voltage signal, and the plurality of power generating units see the phase angle change, and reacts to the phase angle change according to claim 1.

Many of the attendant features will be more readily appreciated as the same become better understood by reference to the following detailed description considered in connection with the accompanying drawings. The preferred features may be combined as appropriate, as would be apparent to a skilled person, and may be combined with any of the aspects of the invention.

### FIGURES

FIG. 1A shows a wind power plant connected to a HVDC power system,

FIG. 1B shows an example of a wind turbine,

FIG. 2 shows an example of a power system of a wind turbine.

FIG. 3 shows generic control structure for phase change detection and taking the necessary actions.

FIG. 4 shows a block diagram of the phase change detection in PLL.

FIG. 5 shows phasor representation of the phase change behaviour.

FIG. 6 shows a block diagram of the FRT state machine related to phase change.

FIG. 7 shows a block diagram of the FRT control block related to phase change.

### DETAILED DESCRIPTION

The description shows an example with a wind farm with a plurality of wind turbines, the invention is not limited to be used in wind turbines, it can in reality be used in all power generating unit which comprises a power inverter, such as solar power, wind power or other types.

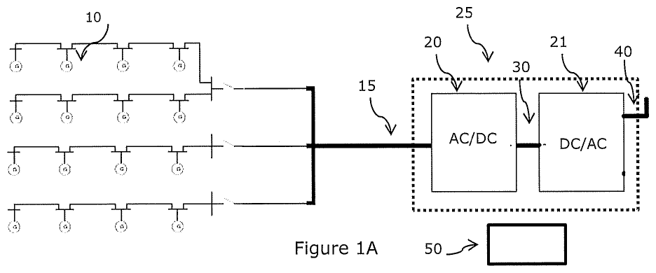

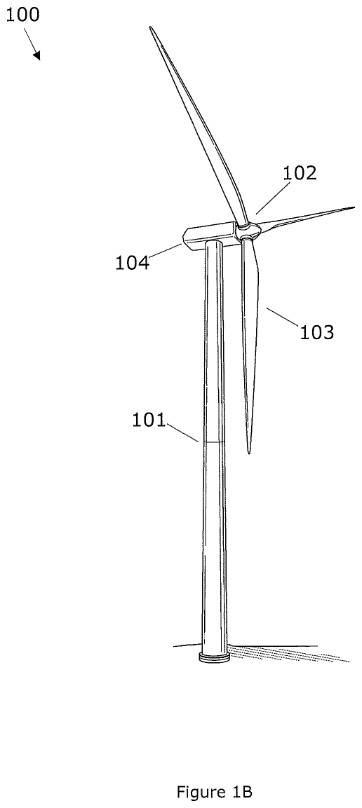

FIG. 1A shows a wind farm 1 with a plurality of wind turbines 10 connected via a common internal grid 15 to an HVDC system 25, the HVDC system 25 comprises a two inverter stations 20, 21, converting AC power to DC power or the other way around. One HVDC inverter station 20 is connected to the wind farm 1, the other HVDC inverter station 21 is connected to an electrical grid 40. For simplicity no other load or suppliers are shown in the figure, but often there can be other loads, and possibly also suppliers on the wind farm side, and obviously there are other loads and suppliers on the grid side, as the system looks into the main electrical grid. This is known to the skilled person.

The HVDC converter system 20, 21 connecting a plurality of wind turbines to a grid via DC connection 30, includes a power converter (HVDC link) and a HVDC converter controller 26 that manages the operation of the HVDC link 25. The HVDC link most often comprises two power converter systems, one at the wind farm site and one connected to the grid. The two converters are connected by a DC transmission system 30. The grid power converter (HVDC link) 25 is configured to receive the AC voltage(s) from the wind farm, convert the AC voltage from the wind farm to obtain a rectified DC voltage, dynamically adjust the level of the filtered DC voltage such that a high-voltage DC (HVDC) signal is produced, and then convert the HVDC signal to an AC voltage at a desired constant frequency that is output as three-phase AC to the power grid.

FIG. 1b shows a wind turbine 100 (WTG) comprising a tower 101 and a rotor 102 with at least one rotor blade 103, such as three blades. The rotor is connected to a nacelle 104 which is mounted on top of the tower 101 and being adapted to drive a generator situated inside the nacelle via a drive train. The rotor 102 is rotatable by action of the wind. The wind induced rotational energy of the rotor blades 103 is transferred via a shaft to the generator. Thus, the wind turbine 100 is capable of converting kinetic energy of the wind into mechanical energy by means of the rotor blades and, subsequently, into electric power by means of the generator. The generator is connected with a power converter which comprises a generator side converter and a line side converter. The generator side converter converts the generator AC power into DC power and the line side converter converts the DC power into an AC power for injection into the utility grid.

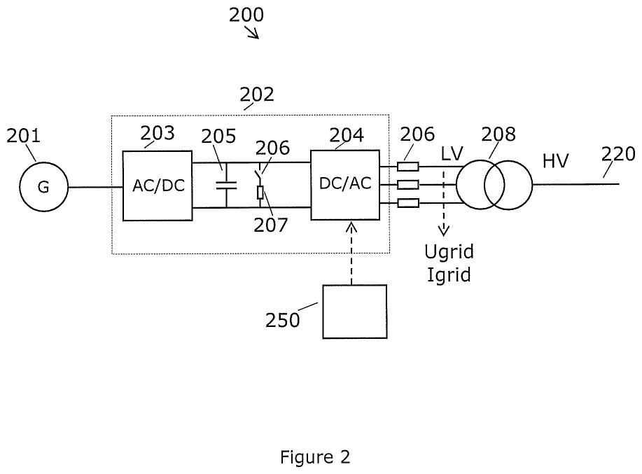

FIG. 2 shows an example of a power system 200 of a wind turbine 100 according to an embodiment. The power system comprises a generator 201 and a power converter 202. The power converter 202 comprises a machine side converter 203, a line side converter 204, a DC-link 205 and a resistor 207 connected with a controllable switch 206. The resistor and switch forms a power dissipation device, also known as a chopper 209, for dissipating active power. The DC-link 205 comprises on or more DC-link capacitors which are charged by the DC output current from the generator side converter 203 and which supplies DC power to the line side converter 204. The output AC current from the line side converter 204 is supplied via output inductors 206 and possibly via a wind turbine transformer 208 to the power line 220. Harmonic filter capacitors 216 arranged between the conductors of the output, together with the inductors 206, forms a harmonic filter which converts the square wave voltage signals from the the line side converter 204 to voltage sinusoidal signals.

Since power system 200 also applies to other power generating unit configured with a full scale power converter 202, the examples and embodiments of the present invention applies equally to other power generating units such as renewable power generating units such as solar power units, e.g. photovoltaic power generating units. That is, the generator 201 may be embodied by solar power generator.

The power line 220 may be a medium voltage power bus which receives power from other wind turbines 100. The power line 220 may be connected with a high voltage network, e.g. via further transformers. Thus, the power line 220 and one or more power systems 200 of corresponding wind turbines constitutes a wind power plant or park arranged to supply power to a utility grid for distribution of electrical power.

The power converter 202 may be full-scale converter configured according to different principles including forced-commutated and line-commutated converters.

The line side converter 204 uses some variant of pulse width modulation (PWM) for converting the DC power into AC power. The control system 250 is used for controlling the modulation of the line side converter 204 and for controlling the active power P and the reactive power Q generated by the line side converter 204.

The line side converter 204 is controlled by a controller, which uses voltage and current signal measured at the input or output of the converter. Among others the the converter controller tracks the voltage signal at the terminals by means of the phase lock loop (PLL), such PLLs are known to the skilled person.

The HVDC system 25 detects a fault in the grid, thus, power shouldn't be delivered to the HVDC converter station at the WTG side. In order to signal to the power generating units, that a fault is present, the HVDC converter controller sets the HVDC converter station at the power generating units side to cause a phase angle jump, in short phase jump. Such a phase jump can be made in different ways, one way would simply be to control the PWM modulated voltage signal the HVDC converter controller 50 generates, to shift in phase angle, this will cause an immediate phase jump. The size of the phase angle jump can be controlled in accordance with the installed power capacity and the impedance of the local grid.

On alternative way on communicating the fault to the power producing units feeding the HVDC, could also be by sending a fault signal via a communication protocol, but this takes time, and may not be received.

The electrical voltage generated by HVDC inverter 20, will be seen by the plurality of wind turbines. The individual wind turbine follows the electrical voltage it sees at its terminal. The voltage signal is processed in the wind turbine converter controller 250, which has a Phase Lock Loop (PLL) so the converter can generate a voltage signal controlled in relation to the voltage at the terminals.

Whenever the HVDC system 20 causes a phase jump, it is detected in the Phase Lock Loop (PLL) of the wind turbine generator converter controller 250.

In normal operation the phase jumps are also relevant, as the jump is momentarily and the PLL takes time to lock to the new angle, in the meantime the voltage vector of the inverter will follow the PLL angle, which is wrong until it is locked back to the new phase angle. The angle error will cause changes in active currents to flow until the voltage vector of the wind turbine is locked to the newly shifted angle. The phase jump will mainly cause disturbances in the active current as the impedance between the wind turbine converter 204 and the grid is primarily the grid choke impedance of the converter. It is therefore better to cap the active current for a period, instead of risking the wind turbine converter 204 to trip, due to overcurrent, or even worse cause a trip in the grid, as a result of larger currents being fed into the grid.

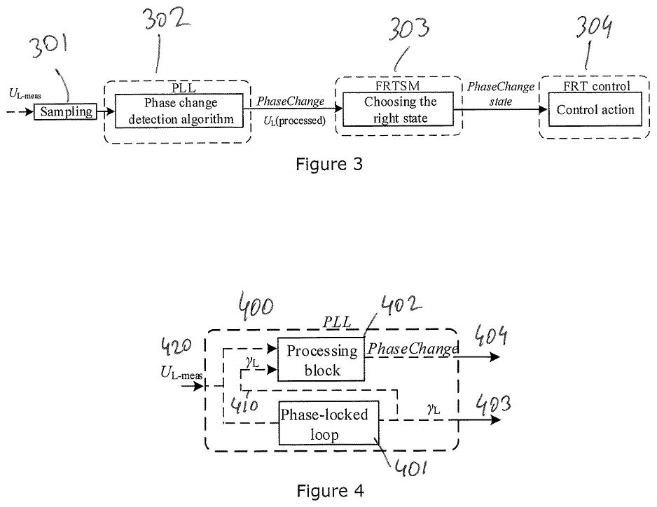

The present invention is a new implementation of a phase measurement and detection algorithm and its combination with a new control action to improve phase change capabilities for electrical generation units. The generic block diagram of the invention can be observed in FIG. 3. The phase voltages are sampled 301 at the terminals of the electrical generation unit. Thereafter, the measured voltage pass through the PLL block 302, where the phase change detection takes place.

The calculated phase change will go through the Fault Ride Through State Machine (FRTSM) 303 along with the processed voltage. FRTSM then decides another and appropriate state, where the electrical generation unit shall operate. Moreover, the FRTSM makes the “phase change” mode activated, and it sends the corresponding signal to the FRT control block 304. Finally, the necessary measures and control action will be taken by the FRT control block 304.

More detailed implementation of the phase change detection has been shown in FIG. 4. Where PLL system block 400, includes a PLL block 401, which acts as a normal phase locked loop system, it receives the measured line voltage 420 and outputs the tracked phase angle 403. The tracked phase angle 403 is input to the processing block 402, which calculates the phase angle change by comparing the actual measured angle with previous measured angle, the processing block outputs the actual phase change 404.

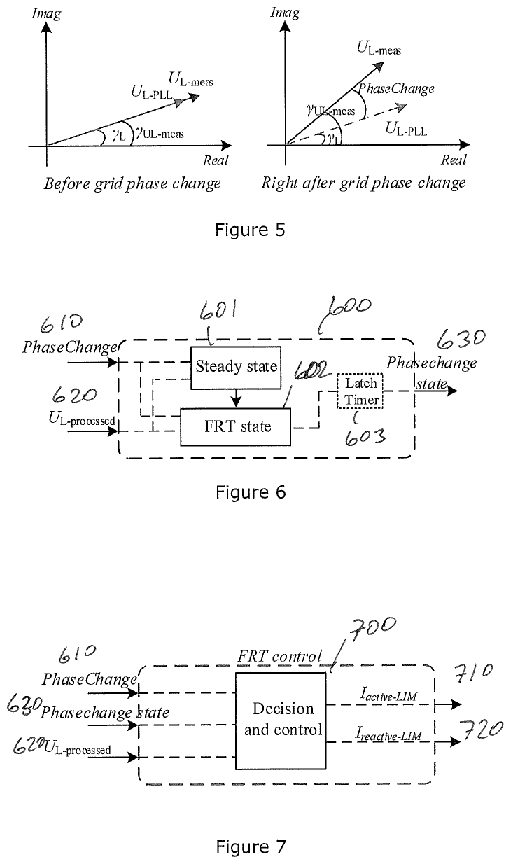

FIG. 5 shows phasor representation of the phase change behaviour. The left figure shows how the phase angle of the measured line voltage, gamma UL_meas is aligned with the tracked PLL phase angle gamma L, thus the voltage vectors UL_PLL and UL_meas are aligned, although they may not have the same length.

The right side of FIG. 5 shows the situation right after the grid phase angle jump, where gamma UL_meas leading gamma L, thus the voltage vectors UL_PLL and UL_meas are misaligned by the PhaseChange angle. The PLL will then try to minimize the PhaseChange, so the two voltage vectors will be aligned, the time it takes depends on how fast the PLL is tuned to react to phase changes.

The instantaneous phase change is measured with calculation of the angle between two vectors. The first vector is the instantaneous voltage space vector measured at the grid U_{L-meas} and the second vector is a unity vector from the PLL output angle U_{L-PLL}, see FIG. 5. The angle between them is a measure of angle difference between the PLL and the grid and will in steady state conditions go towards zero.

In an implementation the phase angle between the two systems is derived where the three phase measured line voltages (UL1, UL2, UL3) are transformed in a Clarke transformation, known to the skilled person.

In an embodiment of the implementation, a new control action/state is triggered if the angle difference gets above an angle threshold value. Generic model of the corresponding part inside FRT state machine 600 can be observed in FIG. 6, FRT means fault ride through. The PhaseChange 610 and the line voltage UL_processed 620 are used as inputs to the FRT state machine 600, both signals are fed to the Steady state block 601 and the FRT state block 602, whenever the PhaseChange 610 exceeds its threshold the FRT state 602 changes and passed the change to the Latch timer block 603, which is optional, and outputs the PhaseChange state 630.

As mentioned earlier, it is important to limit the output of the system, to avoid trips. Thus, the preferred control approach is to put a limitation on the active and reactive current references the electrical unit is allowed to inject, see FIG. 7. The PhaseChange 610, the line voltage UL_processed 620, and PhaseChange state 630 are all used as inputs to the FRT decision and control block 700, which set the current limitations on the active current 710 and on the reactive current 720.

The optional Latch timer block 603 can be implemented to set the time duration to suppress the current injection, if no other control action takes place the current limits are sloped and restored to normal values. It is also an option that slower control loops send new power references to the electrical generation units and prevent it to resume pre phase change condition, so instead it set the conditions to return to a lower power production level, all of which is handled by the FRT decision and control block 700.

The phase angle change can in reality be in either a positive or a negative direction. One direction of the phase angle change will cause the current flowing from the power generating unit(s) to be increased as the resultant voltage vector between the electrical grid and the power generating unit will increase, such an increase will cause circuit breakers and relays to trip. If the phase angle becomes too large the power generating unit(s) may also enter into a power limiting mode. The other direction of the phase angle change will cause the current flowing from the power generating unit(s) to either be reduced or switch direction, depending of the size of the phase angle change, ideally the current will be reduced close to zero, and the inflow of energy from the power generating unit(s) has seized.

Any range or device value given herein may be extended or altered without losing the effect sought, as will be apparent to the skilled person.

It will be understood that the benefits and advantages described above may relate to one embodiment or may relate to several embodiments. It will further be understood that reference to ‘an’ item refer to one or more of those items.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A method for controlling a power generating unit connected to an electrical grid, during a fault ride through event, wherein the fault ride through event causes a phase jump in the electrical grid, the method comprises:
measuring a voltage signal of the power generation unit,
calculating a phase angle, based on the measured voltage, in a phase look loop (PLL) block,
comparing the phase angle with previous measured phase angle, and calculate a phase angle change,
detecting whether the phase angle change is larger than a threshold,
changing to an another state by a Fault Ride Through State machine (FRTSM) for which the power generation unit shall operate, after the threshold has been exceeded, and
deciding a current limitations on the active current 710 and a current limitations on the reactive current 720 output current of the power generating unit.

2. A method according to claim 1, wherein deciding the current limitations comprises a ramp up of the current values.

3. A method according to claim 1, wherein the Fault Ride Through State machine (FRTSM) further comprises a latch timer, which suppresses output current of the power generating unit for a set period of time.

4. A method according to claim 1, wherein the power generating unit is a wind turbine.

5. (canceled)

6. A method according to claim 1, wherein the phase angle jump occurs in a direction which leads to temporary increase in active power of the power generating units.

7. A method according to claim 1, wherein the phase angle jump occurs in a direction which leads to temporary decrease in active power of the power generating units.

8. An electrical power system comprising an HVDC power station and a plurality of power generating units connected to an electrical grid, wherein the HVDC power station generates an output AC voltage signal, with an amplitude and a phase angle, in the event the HVDC power station enters into a fault situation, the fault situation triggers a phase angle change in the voltage signal, and the plurality of power generating units see the phase angle change, and reacts to the phase angle change according to an operation for controlling each power generating unit, during a fault ride through event, wherein the fault ride through event causes a phase jump in the electrical grid, the operation comprises:
measuring a voltage signal of the power generation unit;
calculating a phase angle, based on the measured voltage, in a phase look loop (PLL) block;
comparing the phase angle with previous measured phase angle, and calculate a phase angle change;
detecting whether the phase angle change is larger than a threshold;
changing to an another state by a Fault Ride Through State machine (FRTSM) for which the power generation unit shall operate, after the threshold has been exceeded; and
deciding a current limitations on the active current 710 and a current limitations on the reactive current 720 output current of the power generating unit.
